(19) United States
(12) Patent Application Publication
(10) Pub. No.: US 2025/0016647 A1
(43) Pub. Date: Jan. 9, 2025

(54) 5G NR Handover Schemes

(71) Applicant: Apple Inc., CUPERTINO, CA (US)

(72) Inventors: Fangli XU, Beijing (CN); Alexander SIROTKIN, Hod Hasharon (IL); Dawei ZHANG, Saratoga, CA (US); Haijing HU, Los Gatos, CA (US); Naveen Kumar R PALLE VENKATA, San Diego, CA (US); Pavan NUGGEHALLI, San Carlos, CA (US); Ralf ROSSBACH, Munich (DE); Sarma V VANGALA, Campbell, CA (US); Sethuraman GURUMOORTHY, San Ramon, CA (US); Srirang A LOVLEKAR, Fremont, CA (US); Yuqin CHEN, Beijing (CN); Zhibin WU, Los Altos, CA (US)

(21) Appl. No.: 18/710,675

(22) PCT Filed: Nov. 25, 2021
(86) PCT No.: PCT/CN2021/133247

§ 371 Date: May 16, 2024

(51) Int. Cl. H04W 36/36; H04W 36/00; H04W 72/11; H04W 74/0833

(52) U.S. Cl. CPC H04W 36/362; H04W 36/0079; H04W 72/11; H04W 74/0833

(57) ABSTRACT

A user equipment (UE) is configured to receive a handover command from a source cell, wherein the UE is configured to exchange data with the source cell after the reception of the handover command, perform downlink synchronization acquisition with a target cell while the UE is configured to exchange data with the source cell and transmit an uplink signal to the target cell, wherein the UE stops exchanging data with the source cell after transmitting the uplink signal to the target cell.

### BACKGROUND

This application relates generally to wireless communication, and in particular relates to 5G NR Handover Schemes.

### BACKGROUND

A user equipment (UE) may connect to a node of a network. Once connected, a handover of the UE may occur between a source node and a target node. It has been identified that there exists a need for techniques configured to support a fifth generation (5G) new radio (NR) make before break (MBB) handover scheme. It has also been identified that there exists a need for techniques configured to support a 5G NR random access channel (RACH)-less handover scheme.

### SUMMARY

Some exemplary embodiments are related to a processor of a user equipment (UE) configured to perform operations. The operations include receiving a handover command from a source cell, wherein the UE is configured to exchange data with the source cell after the reception of the handover command, performing downlink synchronization acquisition with a target cell while the UE is configured to exchange data with the source cell and transmitting an uplink signal to the target cell, wherein the UE stops exchanging data with the source cell after transmitting the uplink signal to the target cell.

Other exemplary embodiments are related to a processor of a base station configured to perform operations. The operations include transmitting a handover command to a user equipment (UE), determining whether the UE is configured to remain configured to exchange data with the base station after the reception of the handover command and transmitting a downlink signal to the UE prior to the completion of a handover to a target base station.

Still further exemplary embodiments are related to a processor of a user equipment (UE) configured to perform operations. The operations include receiving a handover command from a source cell and transmitting an uplink signal to a target cell, wherein the uplink signal comprises user data and is a first transmission to be performed to the target cell after the reception of the handover command, wherein the UE does not transmit any signals to the target cell prior to the first transmission.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for fifth generation (5G) new radio (NR) make before break (MBB) handover according to various exemplary embodiments.

FIG. 5 shows a signaling diagram for 5G NR random access channel (RACH)-less handover according to various exemplary embodiments.

FIG. 6 shows a signaling diagram for 5G NR RACH-less handover failure detection according to various exemplary embodiments.

FIG. 7 shows a signaling diagram for 5G NR RACH-less handover failure handling according to various exemplary embodiments.

### DETAILED DESCRIPTION

The exemplary embodiments may be further understood with reference to the following description and the related appended drawings, wherein like elements are provided with the same reference numerals. The exemplary embodiments relate to fifth generation (5G) new radio (NR) handover schemes. As will be described in more detail below, in one aspect, the exemplary embodiments introduce techniques for implementing a 5G NR make before break (MBB) handover scheme. In another aspect, the exemplary embodiments introduce techniques for implementing a 5G NR random access channel (RACH)-less handover scheme.

The exemplary embodiments are described with regard to a user equipment (UE). However, reference to a UE is provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a handover of the UE between a source next generation node B (gNB) and a target gNB. Those skilled in the art will understand that the term “source gNB” generally refers to a gNB that is configured to trigger the handover of the UE. In some examples, the term “source gNB” may be used to refer to a gNB that is going to trigger a handover of the UE and/or to a gNB that has already triggered a handover of the UE, but the handover procedure has not yet been completed.

Those skilled in the art will understand that term “target gNB” generally refers to a gNB that is considered as a potential future serving node for the UE. For example, the source gNB may send a handover preparation request to another gNB. The request may be accepted or denied for any of a variety of different reasons (e.g., admission control, etc.). If the request is accepted, the network may be triggered to initiate a handover of the UE from a source gNB to this gNB in response to any of a variety of different conditions. In some examples, the term “target gNB” may be used to refer to a gNB that is going to receive a handover preparation request from a source gNB and/or to a gNB that has already received the handover preparation request from the source gNB, but the handover procedure has not been completed. Once the handover is complete, the target gNB may then be characterized as a source gNB for the UE in a subsequent handover procedure.

In addition, each gNB may support one or more cells. Throughout this description, the term “source cell” may refer to a cell operated by a source gNB. Similarly, the term “target cell” may refer to a cell operated by a target gNB. Since each gNB may support one or more cells, there may be a scenario in which multiple target cells are associated with the same target gNB.

The exemplary embodiments are described with regard to a MBB handover scheme. Those skilled in the art will understand that MBB handover generally refers to a handover procedure where the connection between the UE and a source cell is maintained after the reception of the handover command. The exemplary embodiments introduce techniques related to when the connection between the UE and the source cell is to be released within the context of a 5G NR MBB handover scheme. In addition, the exemplary embodiments introduce techniques for 5G NR MBB handover failure handling.

The exemplary embodiments are also described with regard to a RACH-less handover scheme. Those skilled in the art will understand that RACH-less handover generally refers to a handover procedure where a RACH procedure is not performed between the UE and the target cell. The exemplary embodiments introduce techniques for implementing a 5G NR RACH-less handover scheme. As will be described in more detail below, these exemplary techniques may include techniques for triggering a RACH-less handover, UE behavior in response to a RACH-less handover command, RACH-less handover failure detection, RACH-less handover failure handling, uplink grant handling and determining a timing advance (TA) for a target cell.

The exemplary embodiments introduce techniques for 5G NR handover schemes. Each of the exemplary techniques described herein may be used independently from one another, in conjunction with currently implemented 5G NR handover schemes, future implementations of 5G NR handover schemes or independently from other 5G NR handover schemes.

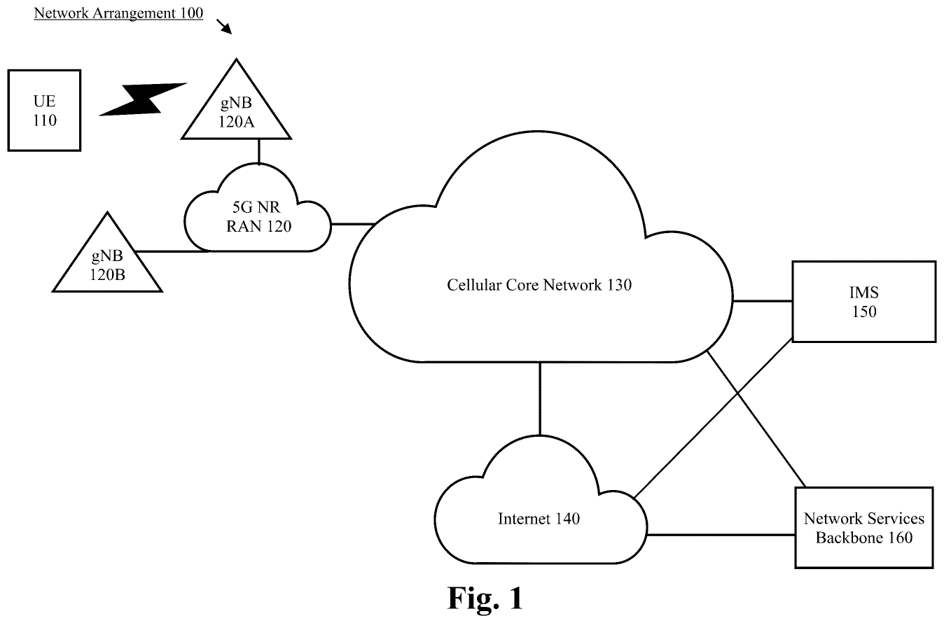

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station (e.g., the gNB 120A, the gNB 120B).

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

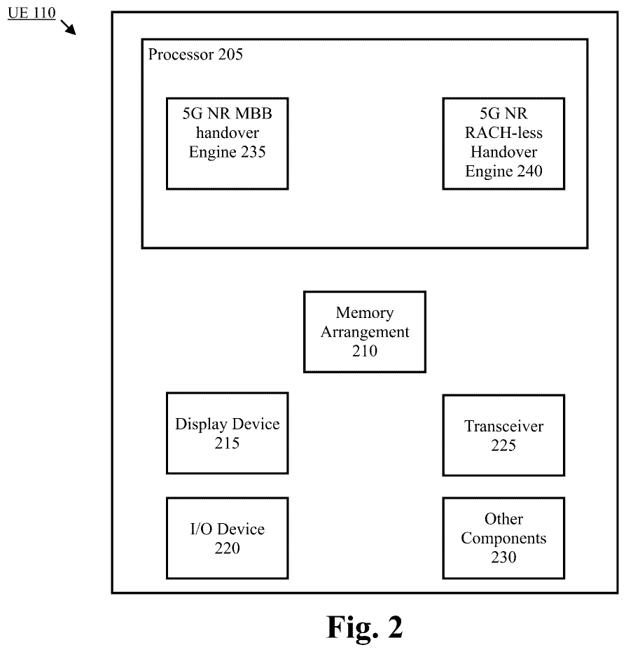

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a 5G NR MBB handover engine 235 and a 5G NR RACH-less handover engine 240. The 5G NR MBB handover engine 235 may be configured to perform various operations related to a MBB handover including, but not limited to, determining when the connection to the source cell is to be released and MBB handover failure handling. The 5G NR RACH-less handover engine 240 may be configured to perform various operations related to a 5G NR RACH-less handover including, but not limited to, RACH-less handover failure detection, RACH-less handover failure handling, uplink grant handling and determining a TA for a target cell.

The above referenced engines 235, 240 being an application (e.g., a program) executed by the processor 205 is merely provided for illustrative purposes. The functionality associated with the engines 235, 240 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines 235, 240 may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

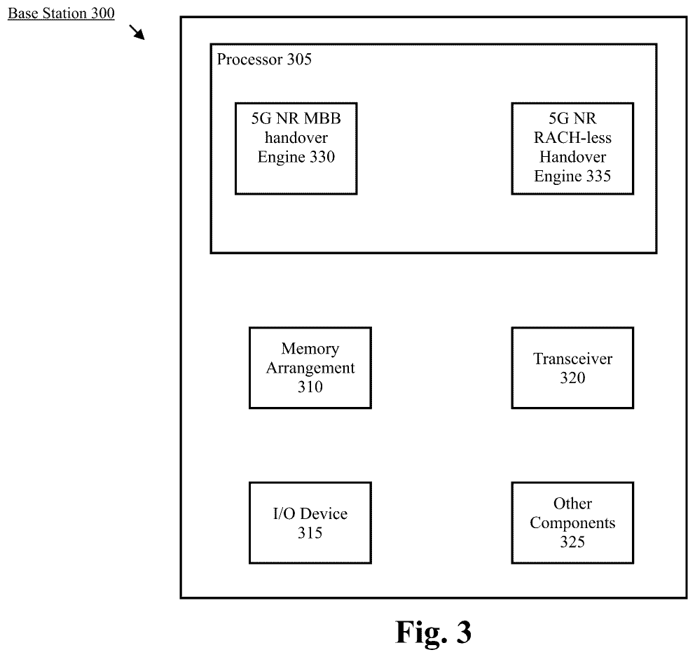

FIG. 3 shows an exemplary base station 300 according to various exemplary embodiments. The base station 300 may represent the gNB 120A, the gNB 120B or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices, one or more transmission reception points (TRPs), etc.

The processor 305 may be configured to execute a plurality of engines 330, 335 for the base station 300. For example, the engines may include a 5G NR MBB handover engine 330 and a 5G NR RACH-less handover engine 335. The 5G NR MBB handover engine 330 may be configured to perform various operations related to a MBB handover including, but not limited to, transmitting a handover preparation request to a target gNB, receiving a handover preparation request from a source gNB, transmitting a handover command to a UE 110 and receiving an indication of MBB handover failure from the UE 110. The 5G NR RACH-less handover engine 335 may be configured to perform various operations related to a RACH-less handover including, but not limited to, transmitting a handover preparation request to a target gNB, receiving a handover preparation request from a source gNB, transmitting a handover command to a UE 110 and transmitting a dynamic downlink grant to the UE 110.

The above noted engines 330, 335 each being an application (e.g., a program) executed by the processor 305 is only exemplary. The functionality associated with the engines 330, 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

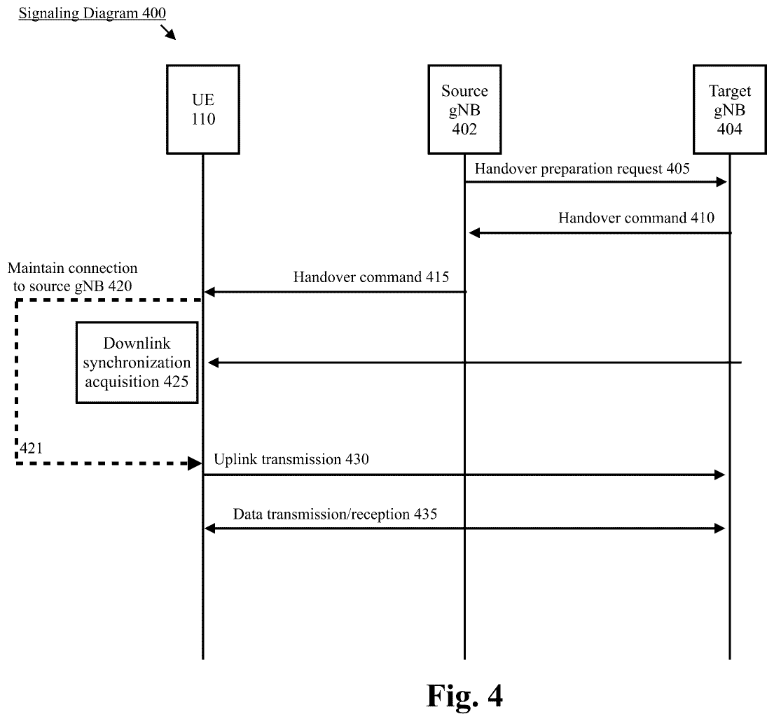

As mentioned above, the exemplary embodiments relate to implementing a 5G NR MBB handover scheme. FIG. 4 shows a signaling diagram 400 for 5G NR MBB handover according to various exemplary embodiments. The signaling diagram 400 includes the UE 110 a source gNB 403 and a target gNB 404.

In this example, it is assumed that the UE 110 and the network each support MBB handover. Although not shown in the signaling diagram 400, the UE 110 may report its support of MBB handover to the network via capability reporting (e.g., access stratum (AS) capability reporting or any other appropriate type of capability reporting). This MBB capability may be specific to frequency range 1 (FR1), specific to frequency range 2 (FR2) or applicable to both FR1 and FR2. Thus, in some embodiments, the UE 110 may report whether it supports MBB for FR1, FR2 or both.

In addition, the UE 110 may report this capability on a per band combination basis. For example, the UE 110 may tune its transceiver 225 and scan for frequency bands that may be used for carrier aggregation (CA) and/or dual-connectivity (DC). The UE 110 may then compile multiple different band combinations based on any of a variety of different factors (e.g., services supported on each band, measurement data, UE preferences, etc.). The UE 110 advertises all or some of the compiled band combinations to the network and then the network configures the UE 110 with one of the advertised band combinations. When the UE 110 supports MBB handover, the UE 110 may indicate whether it supports MBB handover for each reported band combination.

In 405, the source gNB 402 transmits a handover preparation request to the target gNB 404. The request may include a MBB bit flag or any other appropriate indication that the handover preparation request is for a MBB handover. This request may be transmitted to the target gNB 404 over any appropriate interface (e.g., Xn, E1, F1, etc.).

In 410, the target gNB 404 transmits a handover command to the source gNB 402. The handover command may include a MBB bit flag or any other appropriate indication that the handover to be performed is a MBB handover. In this example, it is assumed that the target gNB 404 has decided that a MBB handover of the UE 110 is permitted. However, in an actual deployment scenario, the target gNB 404 may decide to reject the request for the MBB handover for any appropriate reason.

In 415, the source gNB 402 transmits a handover command to the UE 110. The handover command may include a MBB bit flag or any other appropriate indication that the handover to be performed is a MBB handover.

In 420, the UE 110 maintains the connection with the source gNB 402. For MBB handover, the UE 110 may acquire downlink synchronization with the target cell and perform data transmission/reception on the source cell at the same time. Thus, the connection to the source gNB 402 is maintained after the reception of the handover command. In this signaling diagram 400, the duration of time that the UE 110 maintains the connection with the source gNB 402 is shown by the dashed line 421.

In 425, the UE 110 performs downlink synchronization acquisition with the target gNB 404. For example, the UE 110 may search for synchronization signals transmitted by the target gNB 404. The UE 110 may receive one or more synchronization signals from the target gNB 404 (e.g., primary synchronization signal (PSS), secondary synchronization signal (SSS), a synchronization signal block (SSB), physical broadcast channel (PBCH), system information, etc.) while the UE 110 is still connected to the source gNB 402. In other embodiments, the UE 110 may acquire downlink synchronization from the target gNB 404 prior to the reception of the handover command from the source gNB 402.

In 430, the UE 110 performs an uplink transmission to the target gNB 404. This transmission may indicate that the handover is complete. For example, the uplink transmission may be a RACH preamble. However, the exemplary embodiments do not require a RACH procedure to be performed for a MBB handover, MBB techniques may be used in conjunction with RACH-less handovers. Thus, the uplink transmission in 430 may be a RACH preamble and/or the first transmission sent to the target gNB 404 since the handover command was received from the source gNB 402.

When the UE 110 initiates or performs the first uplink transmission to the target gNB 404, the UE 110 may stop transmitting and/or receiving data on the source gNB 402. Thus, the first uplink transmission may serve as a trigger for stopping the exchange of data with the source gNB 402. However, the UE 110 may retain the source cell's configuration and variables. Those skilled in the art will understand that the variables may include L2 context information (e.g., information for reception or transmission in the packet data convergence protocol (PDCP)/radio link control (RLC) layer, information for PDCP reordering, information for RLC data reassembly usage, etc.).

In 435, the UE 110 performs data transmission and/or reception with the target gNB 404. In this example, it is assumed that the RACH procedure is successful or in the case of RACH-less handover, the UE 110 has already been provided with the necessary frequency and timing information to exchange data with the target gNB 404. Specific details for RACH-less handover are provided below after the description of the exemplary techniques for 5G NR MBB handover.

In some embodiments, the UE 110 may provide feedback to the source cell in response to the handover command to indicate whether the UE 110 is to keep the source cell connection during the handover. If the UE 110 indicates that it is not going maintain the connection to the source cell during the handover, the source gNB may stop providing downlink data to the UE 110 and perform a legacy handover to the target gNB. If the UE 110 indicates that it is going to maintain the connection to the source cell during the handover, the source gNB may continue transmission/reception during the handover, e.g., MBB handover.

The UE 110 may provide this feedback to the network via layer 1 (L1), layer 2 (L2) or layer 3 (L3) signaling. For the L1 approach, the UE 110 may deliver the indication via a physical uplink channel (PUCCH)-scheduling request (SR) or a sounding reference signal (SRS). In some embodiments, the uplink resources for the PUCCH-SR or SRS may be dedicated resources provided by the source gNB via radio resource control (RRC) signaling.

For the L2 approach, the exemplary embodiments introduce (MAC) control element (CE) for the MBB feedback indication.

For the L3 approach, the UE 110 may include the indication in a RRC reconfiguration complete message provided in response to the handover command. Alternatively, the indication may be provided in the UE assistance information.

To provide an example within the context of the signaling diagram 400, in response to the handover command in 415, the UE 110 may transmit a signal to the source gNB 402 indicating whether the UE 110 is to keep the source cell connection during the handover procedure. The UE 110 may provide feedback indicating it is to keep the source cell connection if the UE 110 has already acquired downlink synchronization with the target gNB 404 or if the UE 110 is capable of simultaneously acquiring the downlink synchronization with the target gNB 404 and performing transmission/reception with the source gNB 402. In some embodiments, the UE 110 may transmit an indication of support based on UE preference. Thus, there may be a scenario in which the UE 110 indicates to the source gNB 403 that the UE 110 is not going to keep the connection to the source gNB 402 during the handover even though the UE 110 is capable of MBB handover.

In some embodiments, no feedback may indicate to the source gNB 402 that the UE 110 is going maintain the connection to the source cell during the handover or no feedback may indicate to the source gNB 402 that the UE 110 is not going to maintain the connection during the handover. Accordingly, feedback may be provided by the UE 110 to indicate that the UE 110 is not to perform MBB handover, and no feedback may be provided by the UE 110 to indicate that the UE 110 is to perform MBB handover (or vice versa).

The exemplary embodiments also introduce techniques for MBB handover failure handling. The following description of MBB handover failure handling techniques will be described with regard the signaling diagram 400.

In a first approach, the UE 110 may operate a MBB handover failure detection timer. The UE 110 may start the timer when executing MBB handover. For example, the UE 110 may start the timer in response to the handover command 415 or any other appropriate event corresponding to MBB handover. The UE 110 may stop the timer when the first uplink transmission 430 is considered successful. For example, the UE 110 may stop the timer in response to L1 feedback from the target gNB 404 indicating the uplink transmission 430 was successfully received. In another example, the UE 110 may stop the timer in response to receiving an uplink grant or downlink assignment for data transmission after the first uplink transmission 430. If the timer expires, the UE 110 may declare a MBB handover failure. In another approach, the UE 110 may declare a MBB handover failure based on a RACH failure in the target cell.

When the MBB handover failure is detected, the UE 110 may be triggered to perform a legacy handover. For example, the UE 110 may perform a RACH based handover.

In another embodiment, when MBB handover failure is detected, the UE 110 may fallback to the source gNB 402. As indicated above, the UE 110 may retain the source cell configuration and variable after the first transmission in 430. Thus, the UE 110 is able to revert back to the configuration and variables associated with the source cell and transmit a handover failure indication to the source gNB 402.

In contrast to a MBB handover failure where the UE 110 is unable to establish a link to the target gNB 404, there may be a scenario in which the link to the source gNB 402 is broken before the switch to the target cell is complete. In this type of scenario, the UE 110 may focus on completing the handover to the target cell. For example, the UE 110 may still perform the uplink transmission 430 to the target gNB 404 even if the link to the source gNB 402 is broken.

In some embodiments, the MBB handover may be a conditional handover. When the network provides the condition handover commanded, for each conditional cell, the network may indicate whether it's a MBB type handover. On the UE 110 side, when the conditional handover is triggered, the UE 110 may first check whether the target cell is configured for MBB handover based on the indication provided by the network. If the target cell is configured for MBB handover, the UE 110 may perform MBB handover as described above. If the target cell is not configured for MBB handover, a legacy handover may be performed.

MBB techniques may also be used for a secondary cell group (SCG) change. For example, the MBB techniques described herein may be used for a primary secondary cell (PSCell) change, e.g., the UE 110 transitions from a source PSCell to a target PSCell. To provide an example, the network may configure an SCG change indication with a MBB bit flag or any other appropriate indication. During the SCG change procedure, the UE 110 may simultaneously transmit/receive on the source PSCell and perform target PSCell downlink synchronization acquisition. When the UE 110 initiates the RACH procedure in the target PSCell the UE 110 may stop the transmission/reception on the source PSCell.

In another approach, in response to the PSCell change indication, the UE 110 may first check whether the UE 110 has already acquired downlink synchronization with the target PSCell or the UE 110 is capable of acquiring the downlink synchronization with the target PSCell and performing transmission/reception on the source PSCell in parallel. If the UE 110 cannot perform these operations in parallel, the UE 110 may transmit an indication to the source PSCell (or primary node (PN)), that the UE 110 is unable to transmit/receive on the source PSCell during the PSCell change. If the UE 110 is able to perform these operations in parallel, the UE 110 may transmit an indication to the source PSCell (or secondary node (SN)), that the UE 110 is able to transmit/receive on the source PSCell during the PSCell change.

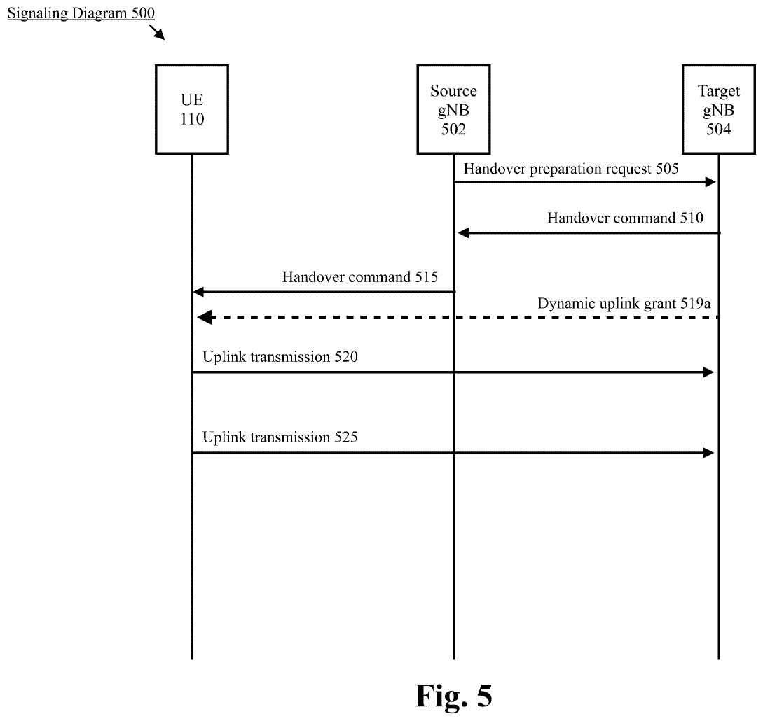

The exemplary embodiments also relate to implementing a 5G NR RACH-less handover scheme. FIG. 5 shows a signaling diagram 500 for 5G NR RACH-less handover according to various exemplary embodiments. The signaling diagram 500 includes the UE 110, a target gNB 502 and a source gNB 504.

In this example, it is assumed that the UE 110 and the network each support RACH-less handover. Although not shown in the signaling diagram 500, the UE 110 may report its support of RACH-less handover to the network via capability reporting (e.g., AS capability reporting or any other appropriate type of capability reporting). This RACH-less capability may be specific to FR, specific to FR2 or applicable to both FR1 and FR2. Thus, in some embodiments, the UE 110 may report whether it supports RACH-less handover for FR1, FR2 or both.

In 505, the source gNB 502 transmits a handover preparation request to the target gNB 504. The request may include a RACH-less handover bit flag or any other appropriate indication that the handover preparation request is for a RACH-less handover. This request may be transmitted to the target gNB 504 over any appropriate interface (e.g., Xn, E1, F1, etc.).

In 510, the target gNB 504 transmits a handover command to the source gNB 502. The handover command may include a RACH-less handover bit flag or any other appropriate indication that the handover to be performed is a RACH-less handover. In this example, it is assumed that the target gNB 504 has decided that a MBB handover of the UE 110 is permitted. However, in an actual deployment scenario, the target gNB 504 may decide to reject the request for the RACH-less handover for any appropriate reason.

In 515, the source gNB 504 transmits the RACH-less handover command to the UE 110. In response to the handover command, the UE 110 may acquire downlink synchronization with the target cell (e.g., gNB 504) and evaluate one or more RACH-less handover conditions. In this example, it is assumed that the RACH-less handover conditions are satisfied and a RACH-less handover to the gNB 504 is triggered. However, in an actual deployment scenario, if the conditions are not triggered the UE 110 may fallback to legacy RACH based handover, declare a handover failure or perform any other appropriate procedure.

The exemplary embodiments introduce conditions that may be used to trigger RACH-less handover. The network may provide the RACH-less handover conditions to the UE 110 or these conditions may be provisioned in any other appropriate manner. In one approach, the RACH-less handover may be triggered based on the target cell radio quality. For example, the UE 110 may collect measurement data associated with the target cell radio quality. If the quality metric is greater than or equal to a threshold value, the UE 110 may trigger RACH-less handover.

In another approach, the RACH-less handover may be triggered based on a downlink timing difference between the source cell and the target cell. For example, the UE 110 may measure a downlink timing in a target cell and calculate a timing difference between the target cell downlink timing and the source cell downlink timing. If the timing difference is less than or equal to a threshold value, the UE 110 may trigger RACH-less handover.

In another approach, the RACH-less handover may be based on a radio quality difference between the source cell and a target cell. For example, the UE 110 may collect measurement data associated with a source cell radio quality and measurement data associated with a target cell radio quality. The UE 110 may then calculate a radio quality difference. If the radio quality difference is less than or equal to a threshold value, the UE 110 may trigger RACH-less handover.

In a further approach, the RACH-less handover may be triggered based on a radio quality threshold associated with a configured grant (CG) provided in the RACH-less handover command. For example, the network may provide a threshold value associated with one or more CGs (assuming the CG configuration is associated with different beams). If the UE 110 cannot detect a suitable beam (e.g., beam quality greater than the threshold of the corresponding CG), the UE 110 may fallback to RACH based handover, declare a handover failure or perform any other appropriate operation.

The RACH-less handover command may include an indication of the uplink resource to be used for the first uplink transmission to the target cell (e.g., uplink transmission 520). For example, the RACH-less handover command may include a Type-1 CG configuration which may provide the UE 110 with the timing and frequency information to perform an uplink transmission to the target cell.

As indicated above, the network may provide an uplink grant to the UE 110 in the RACH-less handover command. In this example, the uplink grant configuration may reuse the type-1 CG configuration or the small data transmission (SDT) uplink resource configuration structure. The SDT uplink resource configuration can support one CF resource associated with multiple beams. The network may configure the CG configuration and the associated beams. One CG configuration may be associated with more than one beam and the network may configured multiple CG configurations. The UE 110 may then select the CG configuration/resource for transmission based on the associated beam quality.

The UE 110 may use the uplink grant for the first uplink transmission to the target cell (e.g., uplink transmission 520). After the first uplink transmission, the UE 110 may handle the uplink grant in any of a variety of different ways. In one approach, the UE 110 may keep the uplink grant for subsequent uplink transmission until the network releases the uplink grant via L1, L2 or L3 signaling. In another approach, the UE 110 may stop using the uplink grant for the subsequent transmission until the network explicitly indicates to the UE 110 to continue using the uplink grant. In another approach, the UE 110 may release the uplink grant when the first uplink transmission to the target cell (e.g., uplink transmission 520) is complete. In some embodiments, the uplink grant may be used for the retransmission of the first uplink transmission to the target cell (e.g., retransmission of uplink transmission 520 (not pictured)).

In some examples, the RACH-less handover command may include TA information that may be used for the first uplink transmission in the target cell (e.g., uplink transmission 520). In some embodiments, the TA value for the target cell may be same as the source primary cell (PCell) TA value (e.g., source gNB 502). In another embodiment, the TA value for the target cell may be the same as the source PSCell TA value (e.g., source gNB 502). In a further embodiment, the TA value may be the same as the source TAG #X TA value. Those skilled in the art will understand that the term TAG refers to the timing advance group and TAG #X represents the Xth TAG. When the UE 110 is working in CA or DC, if the TA value is different for different serving cells, the network may configure the serving cells in a different TAG. Within each TAG, the UE 110 maintains its own downlink sync and uplink TA value. The TAG #X may be used if a SCell TA is different from the current PCell but the same at the target PCell. The network may indicate to the UE 110 to use the SCell TA value for initial access in the target cell.

In another embodiment, the TA value may be equal to zero. In some embodiments, the UE 110 may calculate the TA value. Exemplary techniques that may be used by the UE 110 to calculate the TA value for RACH-less handover are provided in detail below.

The UE 110 may derive the uplink TA for the first uplink transmission (e.g., transmission 520). If the network indicates that the UE 110 is to use a UE based TA calculation, the UE 110 will calculate the target cell uplink TA. This calculation may be based on the downlink timing difference between the source and target cell. For example, if the downlink timing difference is (X), the relative uplink TA may be (2*X).

The UE 110 may start the TA timer for the target cell in response to any of a variety of different conditions. In one example, the UE 110 may start the TA timer when the UE 110 receives the RACH-less handover command. In another example, the UE 110 may start the TA timer when the UE 110 performs the first uplink transmission (e.g., uplink transmission 520). In another example, the UE 110 may start the TA timer when the UE 110 derives the uplink TA.

As mentioned above, in this example, it is assumed that RACH-less handover is triggered. In 520, the UE 110 performs an uplink transmission. The uplink transmission may include an indication that the handover is complete, user data and/or any other appropriate information. However, this is a RACH-less handover and the UE 110 does not include any information for a RACH procedure. Alternatively, this may have no impact on the TA timer or the TA timer configured to control uplink synchronization may be disabled.

If the TA timer is configured in the handover command expires during RACH-less handover, a handover failure may be declared. In this type of scenario, if the first uplink transmission has not been performed, the UE 110 may fallback to RACH-based handover. Otherwise, if the TA timer expiry occur when performing a retransmission, the UE 110 may fallback to legacy RACH-less handover or declare a handover failure. The UE 110 may restart the TA timer upon receiving the timing advance command (TAC) to indicate the update of the target cell TA information.

If uplink grants are configured in the handover command, the UE 110 may select an uplink grant with a suitable beam and perform the uplink transmission in 520. If there is no valid CG for transmission to the target cell, the UE 110 may monitor the dynamic scheduling in the source gNB 502 (not shown) or declare a handover failure.

Alternatively, the UE 110 may monitor a physical downlink control channel (PDCCH) in the target cell for a dynamic uplink grant as example of which is shown in the signaling diagram 500 as dynamic uplink grant 519a.

To perform the uplink transmission in 520, the UE 110 may use the TA indication provided in the handover command or calculated by the UE 110 itself.

In 525, the UE 110 performs another uplink transmission to the gNB 504. This transmission is provided to illustrate that the UE 110 can perform subsequent transmissions and does not need to wait for the network to provide a contention resolution (CR) MAC CE.

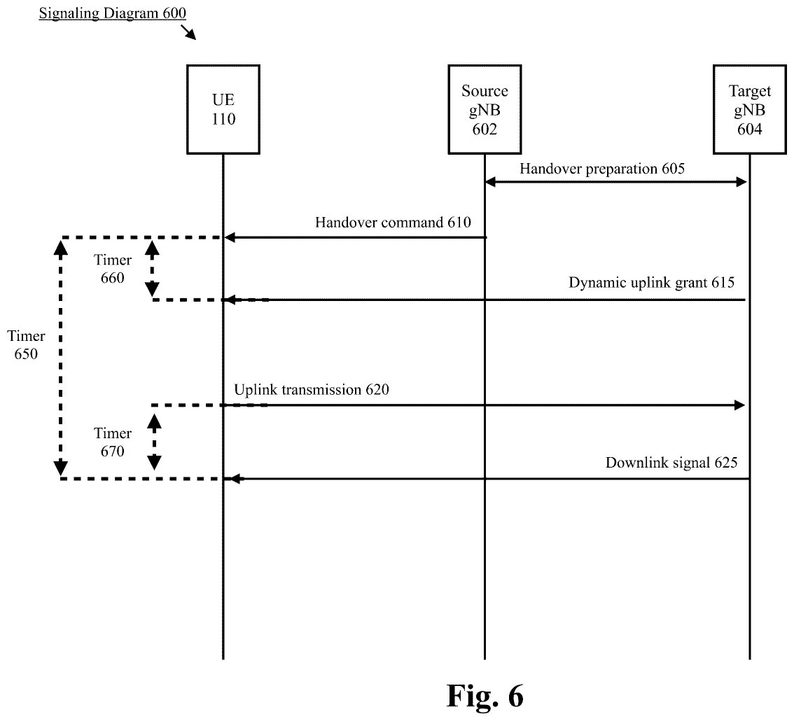

FIG. 6 shows a signaling diagram 600 for 5G NR RACH-less handover failure detection according to various exemplary embodiments. The signaling diagram 600 includes the UE 110, a target gNB 602 and a source gNB 604.

The signaling diagram 600 shows three different types of timers 650-670 that mat be used for 5G NR RACH-less handover failure detection. A description of these timers will be provided below after a general overview of the signaling shown in the signaling diagram 600 is described.

In 605, the source gNB 602 and the target gNB 604 perform handover preparation. This is similar to signals 505-510 in the signaling diagram 500.

In 610, the source gNB 604 transmits a handover command to the UE 110. As indicated above in the signaling diagram 500, the handover command may include a RACH-less handover bit flag, uplink resources that may be used to perform a transmission of user data to the target gNB 504 and/or TA information.

In 615, the target gNB 504 transmits a dynamic uplink grant to the UE 110. This is similar to the dynamic uplink grant 519a of the signaling diagram 500.

In 620, the UE 110 performs an uplink transmission to the gNB 604. The uplink transmission may include an indication that the handover is complete, user data and/or any other appropriate information. However, since RACH-less handover has been triggered, the UE 110 does not include any information for a RACH procedure.

In 625, the gNB 604 transmits a downlink signal to the UE 110. In one example, the downlink signal may be an L1 acknowledgement (ACK) in response to the uplink transmission in 620. In another example, the downlink signal may be L1 scheduling for subsequent uplink or downlink communications. Thus, the downlink signal may be provided directly in response to the uplink transmission in 520 (e.g., ACK) or the uplink transmission may indicate to the gNB 604 that the handover is complete and subsequent communication may be performed with the UE 110 (e.g., L1 scheduling).

As indicated above, the exemplary embodiments introduce three different timers that may be used for RACH-less handover failure detection. Although shown together in the signaling diagram 600, these timers may be used independently from one another.

The UE 110 may detect a RACH-less handover failure based on timer 650. The UE 110 may start timer 650 when executing the RACH-less handover (e.g., in response to the handover command). The UE 110 may stop timer 650 when the UE 110 determines that the uplink transmission 620 was successful. This determination may be made based on the reception of the downlink signal in 625 (e.g., L1 feedback, uplink grant, downlink assignment for data transmission, etc.). If the timer 650 expires, the UE 110 may declare a RACH-less handover failure.

In addition, the UE 110 may detect a RACH-less handover failure based on timer 660. The UE 110 may start timer 660 when executing the RACH-less handover (e.g., in response to the handover command or when acquiring downlink timing in the target cell). The UE 110 may stop timer 660 when receiving the first uplink grant from the target cell (e.g., dynamic uplink grant 615. If the timer 660 expires, the UE 110 may declare a RACH-less handover failure.

Further, the UE 110 may detect a RACH-less handover failure based on timer 670. The UE 110 may start the timer 670 in response to transmitting the first uplink transmission 620. The UE 110 may stop the timer 670 when receiving a L1 ACK in response to the first uplink transmission 620 or when receiving L1 scheduling for a subsequent uplink/downlink transmission (e.g., downlink signal 625). If the timer 670 expires, the UE 110 may declare a RACH-less handover failure.

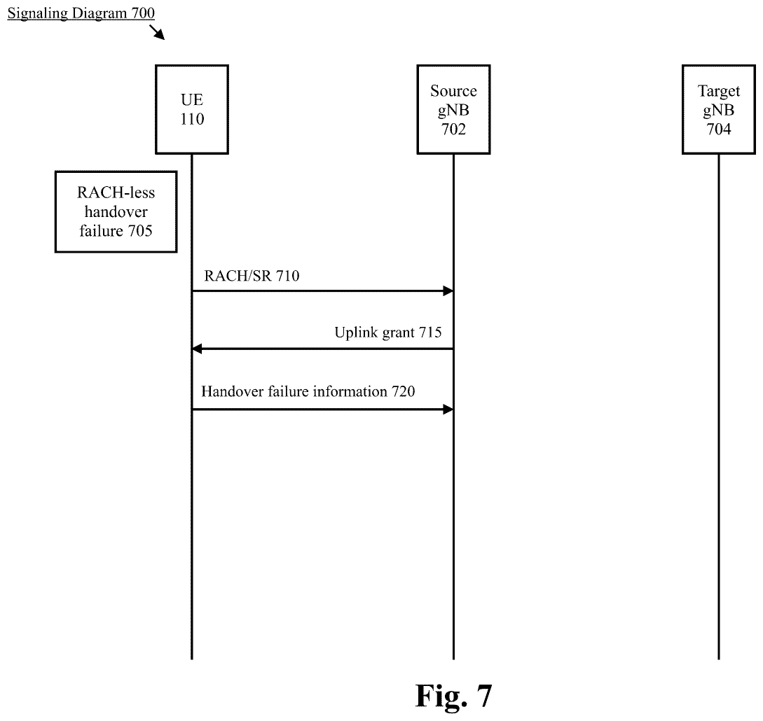

In one approach, when RACH-less handover is detected, the UE 110 may perform a RACH based handover with the target cell. In another approach, when RACH-less handover is detected, the UE 110 may fallback to the source cell link and information the source cell about the handover failure. An example of this RACH-less handover failure handling is shown in the signaling diagram 700 of FIG. 7.

The signaling diagram 700 includes the UE 110, a source gNB 702 and a target gNB 704. In 705, the UE 110 detects a RACH-less handover failure. In 710, the UE 110 transmits a RACH signal and/or a SR to the source gNB 702. In 715, the source gNB 702 transmits an uplink grant to the UE 110. In 720, the UE 110 transmits handover failure information to the source gNB 702. This may include an indication that the RACH-less handover was not complete and/or UE assistance information. Those skilled in the art will understand that the failure handling shown in the signaling diagram 700 for RACH-less handover may also be used for a MBB handover failure. In addition, it is also understood, that the MBB failure handling techniques described above may also be used for RACH-less handover failure.

The exemplary RACH-less handover techniques may be used in conjunction with conditional handover. For example, the network may configure RACH-less handover using a conditional handover command. Once triggered, the RACH-less scheme may be applicable on the target cell. The conditional handover candidate cell selection may be based on conditional handover scheme. Alternatively, the UE 110 may prioritize the candidate cell that supports RACH-less handover during candidate cell selection.

In addition, the exemplary RACH-less handover techniques may also be used in conjunction with dual-active protocol stack (DAPS) handover techniques. In DAPS, the UE 110 have a simultaneous connection to a source cell and a target cell after the reception of the handover command. The DAPS framework may be configured to include a RACH-less handover instead of a RACH based handover if RACH-less handover is supported by the UE 110 and the target cell.

Further, the exemplary RACH-less handover techniques may also be applicable to SCG in DC. In this scenario, the network may configure the RACH-less access for SCG addition/reconfiguration.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
receiving a handover command from a source cell, wherein the UE is configured to exchange data with the source cell after the reception of the handover command;
performing downlink synchronization acquisition with a target cell while the UE is configured to exchange data with the source cell; and
transmitting an uplink signal to the target cell, wherein the UE stops exchanging data with the source cell after transmitting the uplink signal to the target cell.

2. The processor of claim 1, wherein the UE retains a source cell configuration after transmitting the uplink signal.

3. The processor of claim 1, the operations further comprising:
transmitting feedback to the source cell in response to the handover command, wherein the feedback indicates that the UE is to remain configured to exchange data with the source cell after the reception of the handover command.

4. The processor of claim 3, wherein the feedback is provided in a physical uplink control channel (PUCCH) scheduling request (SR) or a sounding reference signal (SRS).

5. The processor of claim 3, wherein the feedback is provided in a medium access control (MAC) control element (CE).

6. The processor of claim 3, wherein the feedback is provided in a radio resource control (RRC) configuration complete message or UE assistance information.

7. The processor of claim 1, the operations further comprising:
declaring a handover failure based on not receiving a response to the uplink signal transmitted to the UE prior to the expiration of a timer operated by the UE.

8. The processor of claim 7, the operations further comprising:
performing a random access channel (RACH) based handover with the target cell in response to the handover failure.

9. The processor of claim 8, the operations further comprising:
transmitting an indication of the handover failure to the source cell, wherein the UE fallbacks to the source cell configuration in response to the handover failure.

10. The processor of claim 1, the operations further comprising:
declaring a handover failure based on random access channel (RACH) failure with the target cell; and
transmitting an indication of the handover failure to the source cell, wherein the UE fallbacks to the source cell configuration in response to the handover failure.

11. The processor of claim 1, wherein the handover command is for a conditional handover and indicates that the target cell supports make before break handover.

12. A processor of a base station configured to perform operations, comprising:
transmitting a handover command to a user equipment (UE);
determining whether the UE is configured to remain configured to exchange data with the base station after the reception of the handover command; and
transmitting a downlink signal to the UE prior to the completion of a handover to a target base station.

13. The processor of claim 12, wherein determining that the UE is to remain configured to exchange data with the base station after the reception of the handover command based on receiving feedback from the UE in response to the handover command.

14. The processor of claim 13, wherein the feedback is provided in a physical uplink control channel (PUCCH) scheduling request (SR), a sounding reference signal (SRS), a medium access control (MAC) control element (CE), a radio resource control (RRC) configuration complete message or UE assistance information.

15. (canceled)

16. (canceled)

17. A processor of a user equipment (UE) configured to perform operations comprising:
receiving a handover command from a source cell; and
transmitting an uplink signal to a target cell, wherein the uplink signal comprises user data and is a first transmission to be performed to the target cell after the reception of the handover command, wherein the UE does not transmit any signals to the target cell prior to the first transmission.

18. The processor of claim 17, wherein the handover command comprises a type-1 configured grant (CG) configuration or timing advance (TA) information to be used for the first transmission.

19. (canceled)

20. The processor of claim 17, the operations further comprising:
receiving a dynamic uplink grant from the target cell, wherein the dynamic uplink grant is to be used for the first transmission.

21. The processor of claim 17, the operations further comprising:
initiating a timer in response to the handover command;
monitoring for a downlink signal from the target cell after the first transmission, wherein the timer expires prior to the reception of the downlink signal; and
declaring a handover failure based on the timer.

22. (canceled)

23. The processor of claim 17, the operations further comprising:
initiating a timer;
receiving, a dynamic uplink grant from the target cell to be used for the first transmission;
stopping the timer in response to the dynamic uplink grant, wherein the UE is configured to declare a handover failure if the dynamic uplink grant is not received prior to the expiration of the timer.

24. The processor of claim 17, the operations further comprising:
initiating a timer in response to the first transmission;
monitoring for a downlink signal from the target cell in response to the first transmission, wherein the timer expires prior to the reception of the downlink signal; and
declaring a handover failure based on the timer.

25-34. (canceled)
